(19) United States
(12) Patent Application Publication
(10) Pub. No.: US 2019/0243355 A1
(43) Pub. Date: Aug. 8, 2019

(54) REMOTE CONTROL SYSTEM AND COMMUNICATION METHOD THEREFOR

(71) Applicant: TOYOTA JIDOSHA KABUSHIKI KAISHA, Toyota-shi (JP)

(72) Inventors: Hiroki IZU, Nagoya-shi (JP); Yu Sasaki, Toyota-shi (JP)

(73) Assignee: TOYOTA JIDOSHA KABUSHIKI KAISHA, Toyota-shi (JP)

(21) Appl. No.: 16/240,819

(22) Filed: Jan. 7, 2019

(30) Foreign Application Priority Data
Feb. 2, 2018 (JP) 2018-017303

(51) Int. Cl. G05D 1/00; H04N 21/2343; G02B 27/01

(52) U.S. Cl. CPC G05D 1/0038; G05D 1/0022; G05D 1/0016; G02B 2027/0187; H04N 21/234381; G02B 27/0179; G02B 27/017; H04N 21/234363

(57) ABSTRACT

A remote control system includes: a moving object including shooting means, and image quality changing means; controller means by which an operator remotely controls the moving object; and display means for cutting out a predetermined range from the image data transmitted from the image quality changing means according to a direction in which the operator is facing and displaying the cut-out predetermined range for the operator. The image quality changing means increases a frame rate of the image data taken by the shooting means and lowers the resolution of the image data according to the increase in the frame rate when at least one of following conditions is satisfied: a condition that a moving speed of the moving object increases; and a condition that a setting is changed through the controller means so that the frame rate of the image data taken by the shooting means increases.

### CROSS REFERENCE TO RELATED APPLICATIONS

This application is based upon and claims the benefit of priority from Japanese patent application No. 2018-017303, filed on Feb. 2, 2018, the disclosure of which is incorporated herein in its entirety by reference.

### BACKGROUND

The present disclosure relates to a remote control system for remotely controlling a moving object and its communication method.

A remote control system including a moving object equipped with shooting means (e.g., video-shooting means), controller means by which an operator remotely controls the moving object, and display means that is attached to the operator operating the controller means and displays images of image data taken by the shooting means has been known (see, for example, Japanese Unexamined Patent Application Publication No. 2003-267295).

The present inventors have found the following problem. For example, when the moving object moves at a high speed, images displayed in the display means become discontinuous and hence there is a possibility that the sense of immersion that the operator is feeling is impaired. Therefore, the frame rate of the images in the display means is adjusted to a high value according to the high moving speed of the moving object. However, when the frame rate of the images in the display means is adjusted to the high value, the amount of communication for the image data transmitted from the shooting means to the display means increases and hence the communication load of the image data increases. Therefore, it is desired to maintain the sense of immersion and reduce the communication load at the same time when the moving object is moving at a high speed.

### SUMMARY

The present disclosure has been made to solve the above-described problem and an object thereof is to provide a remote control system and its communication method capable of maintaining a sense of immersion and reduce a communication load at the same time when a moving object is moving at a high speed.

A first exemplary aspect to achieve the above-described object is a remote control system including:

a moving object including: shooting means; and image quality changing means for changing a resolution of image data taken by the shooting means;

controller means by which an operator remotely controls the moving object; and

display means for cutting out a predetermined range from an image of the image data transmitted from the image quality changing means of the moving object according to a direction in which the operator is facing and displaying an image of the cut-out predetermined range for the operator, the display means being configured to be attached to the operator operating the controller means, in which

the image quality changing means increases a frame rate of the image data taken by the shooting means and lowers the resolution of the image data according to the increase in the frame rate when at least one of following conditions is satisfied:

a condition that a moving speed of the moving object increases; and

a condition that a setting is changed through the controller means so that the frame rate of the image data taken by the shooting means increases.

In this aspect, the display means may include direction detection means for detecting a direction in which the operator is facing, the display means may display the image of the predetermined range included in the image data changed by the image quality changing means for the operator, the predetermined range being a range centered on the direction in which the operator is facing detected by the direction detection means, and the image quality changing means may lower the resolution of the image data taken by the shooting means by defining an area in the predetermined range in the image data centered on the direction in which the operator is facing detected by the direction detection means as a high image quality area and changing an area outside the predetermined range to a low image quality area having a resolution lower than that of the high image quality area.

In this aspect, the image quality changing means may extend the low image quality area as the frame rate of the image data taken by the shooting means increases.

In this aspect, the image quality changing means may estimate an area in the low image quality area that the operator cannot see based on a moving speed of a head of the operator and set the estimated area as a non-image area where there is no image.

In this aspect, the image quality changing means may gradually lower the resolution of the low image quality area as a distance from the high image quality area increases.

In this aspect, the image data may be transmitted from the image quality changing means to the display means wirelessly or through a wire. Further, an upper limit value for an amount of communication per unit time for transmission of the image data may be set for the wireless transmission of the wired transmission.

In this aspect, the image quality changing means may lower the resolution of the image data taken by the shooting means when the frame rate of the image data taken by the shooting means is higher than a predetermined value.

In this aspect, the shooting means may be an omnidirectional camera configured to omnidirectionally shoot the moving object.

In this aspect, the moving object may be a submersible apparatus configured to move under water.

In this aspect, the image quality changing means may lower the resolution of the image data taken by the shooting means according to an increase in the frame rate of the image data and decrease an amount of reduction in the resolution according to a depth of the moving object or a degree of transparency of water around the moving object.

In this aspect, the image data whose resolution has been changed by the image quality changing means may be wirelessly transmitted from the image quality changing means to the display means through water. Further, the image quality changing means may lower the resolution of the image data taken by the shooting means according to an increase in the frame rate of the image data and increase an amount of reduction in the resolution according to a distance of the wireless transmission in the water.

Another exemplary aspect to achieve the above-described object may be a communication method for a remote control system, the remote control system including:

a moving object including: shooting means; and image quality changing means for changing a resolution of image data taken by the shooting means;

controller means by which an operator remotely controls the moving object; and

display means for cutting out a predetermined range from an image of the image data transmitted from the image quality changing means of the moving object according to a direction in which the operator is facing and displaying an image of the cut-out predetermined range for the operator, the display means being configured to be attached to the operator operating the controller means,

the communication method including increasing a frame rate of the image data taken by the shooting means and lowering the resolution of the image data according to the increase in the frame rate when at least one of following conditions is satisfied:

a condition that a moving speed of the moving object increases; and

a condition that a setting is changed through the controller means so that the frame rate of the image data taken by the shooting means increases.

According to the disclosure, it is possible to provide a remote control system and its communication method capable of maintaining a sense of immersion and reduce a communication load at the same time when a moving object is moving at a high speed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a schematic configuration of a remote control system according to a first embodiment of the present disclosure;

FIG. 2 is a block diagram showing a schematic configuration of the remote control system according to the first embodiment of the present disclosure;

FIG. 3 is a graph showing an example of map information indicating a relation between moving speeds of a moving object and resolutions;

FIG. 4 is a flowchart showing a flow of a communication method performed by the remote control system according to the first embodiment of the present disclosure;

FIG. 5 is a diagram showing a high image quality area and a low image quality area;

FIG. 6 is a graph showing an example of map information indicating a relation between moving speeds of a moving object and sizes of a low image quality area;

FIG. 7 is a diagram showing an example of a non-image area; and

FIG. 8 is a flowchart showing a flow of a communication method performed by a remote operation system according to a second embodiment of the present disclosure.

### DESCRIPTION OF EMBODIMENTS

### First Embodiment

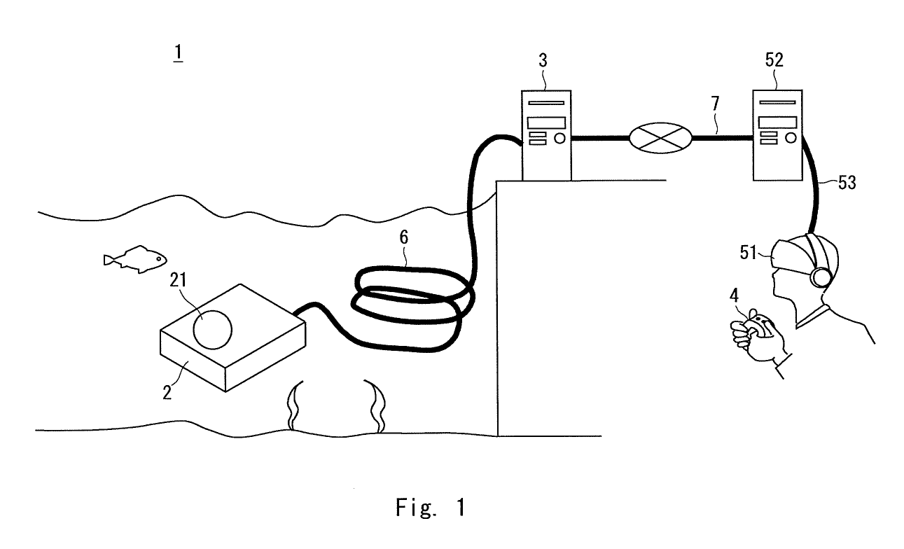

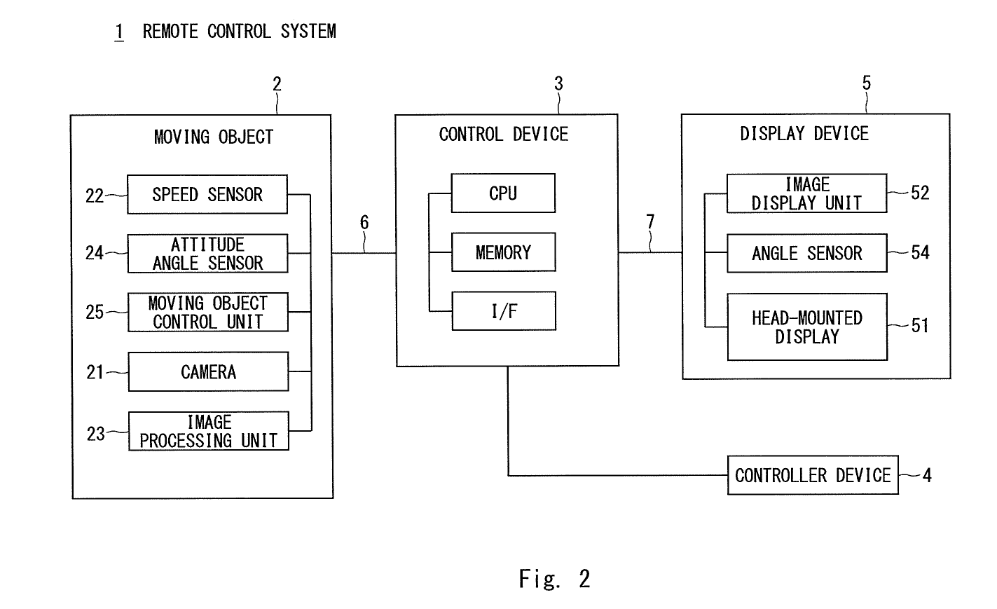

Embodiments according to the present disclosure will be described hereinafter with reference to the drawings. FIG. 1 shows a schematic configuration of a remote control system according to a first embodiment of the present disclosure. FIG. 2 is a block diagram showing a schematic configuration of the remote control system according to the first embodiment. The remote control system 1 according to the first embodiment remotely controls a moving object 2. The remote control system 1 according to the first embodiment includes, besides the moving object 2 which autonomously moves, a control device 3 that controls the moving object 2, a controller device 4 for controlling the moving object 2, and a display device 5 that displays images for an operator.

The moving object 2 is, for example, an unmanned submersible apparatus (an underwater drone). The moving object 2 includes a camera 21 that shoots (e.g., takes moving images of) surroundings of the moving object 2, a speed sensor 22 that detects a moving speed of the moving object 2, an image processing unit 23 that changes a resolution of image data, an attitude angle sensor 24 that detects attitude angles of the moving object 2, and a moving object control unit 25 that controls the moving object 2.

The camera 21 is a specific example of the shooting means. The camera 21 is an omnidirectional camera that omnidirectionally shoots the moving object 2 (i.e., takes an omnidirectional image(s) of the moving object 2). The omnidirectional camera is configured, for example, to take an image of a visual field that covers an entire sphere or a hemisphere, or a belt-like image of a 360-degree visual field. The omnidirectional camera may be composed of a plurality of cameras. In such a case, the omnidirectional camera may be configured to take an image of a visual field that covers an entire sphere or a hemisphere, or a belt-like image of a 360-degree visual field by combining images taken by the plurality of cameras.

The speed sensor 22 detects a moving speed of the moving object 2 and outputs the detected moving speed to the image processing unit 23 and the moving object control unit 25.

The image processing unit 23 is a specific example of the image quality change unit. The image processing unit 23 changes the resolution of image data taken by the camera 21. Note that the image processing unit 23 may be incorporated into the camera 21.

When the moving speed of the moving object 2 detected by the speed sensor 22 has increased, the image processing unit 23 increases the frame rate of image data taken by the camera 21. For example, the image processing unit 23 increases the frame rate of image data taken by the camera 21 as the moving speed of the moving object 2 detected by the speed sensor 22 increases. Further, the image processing unit 23 may increase the frame rate of image data taken by the camera 21 when the moving speed of the moving object 2 detected by the speed sensor 22 becomes equal to or higher than a predetermined value. In this way, it is possible to display image data taken by the moving object 2 as smoothly moving images even when the moving object 2 moves at a high speed.

Note that the image processing unit 23 may increase the frame rate of image data taken by the camera 21 when a setting of the camera 21 is changed through the controller device 4 so that the frame rate of the image data increases.

The attitude angle sensor 24 detects attitude angles of the moving object 2, such as a yaw angle, a pitch angle, a roll angle, etc. of the moving object 2, and outputs the detected attitude angles to the moving object control unit 25.

The moving object control unit 25 controls the attitude (i.e., the posture), the moving speed, etc. of the moving object 2 based on the attitude angles of the moving object 2 detected by the attitude angle sensor 24, the moving speed of the moving object 2 detected by the speed sensor 22, and a control signal transmitted from the control device 3. For example, the moving object control unit 25 performs feedback control for all the axes, i.e., for the roll axis, the pitch axis, and the yaw axis based on the attitude angles of the moving object 2 detected by the attitude angle sensor 24 and thereby controls the attitude of the moving object 2 in the roll direction, the pitch direction, and the yaw direction.

The control unit 3 is installed, for example, on the ground. However, the control device 3 may instead be installed in the water. The control device 3 and the moving object 2 are connected to each other through, for example, a wire 6 such as a cable. Note that the control device 3 and the mobile object 2 may be wirelessly connected to each other for communication therebetween by using, for example, visible light or infrared light. The image processing unit 23 transmits the image data whose resolution has been changed to the display device 5 through the wired 6 and the control device 3.

The control unit 3 controls movements of the moving unit 2 according to an operation signal transmitted from the controller device 4. The control device 3 generates a control signal corresponding to the operation signal transmitted from the controller device 4 and transmits the generated control signal to the moving object control portion 25 of the moving object 2.

Note that the control device 3 and the moving object control unit 25 are formed by, for example, hardware mainly using a microcomputer including: a CPU (Central Processing Unit) that performs arithmetic processing, control processing, etc.; a memory that stores arithmetic programs, control programs, etc. executed by the CPU, and various data; an interface unit (I/F) that externally receives and outputs signals, and so on. The CPU, the memory, and the interface unit are connected with each other through a data bus or the like.

The controller device 4 is a specific example of the controller means. The controller device 4 generates an operation signal according to an operation performed by an operator and transmits the generated operation signal to the control device 3. The control device 3 and the controller device 4 are wirelessly connected to each other for communication therebetween (hereinafter also expressed as communicatively connected to each other) by using, for example, a Bluetooth® technique or a Wifi® technique. The control device 3 and the controller device 4 may be communicatively connected to each other through, for example, a network such as the Internet. The control device 3 and the controller device 4 may be communicatively connected to each other through a wire. The controller device 4 includes, for example, a joystick, switches, buttons, etc. which are operated by the operator. The controller device 4 may be a portable terminal such as a smartphone. The controller device 4 and the display device 5 may be integrally formed.

The display device 5 is a specific example of the display means. The display device 5 includes a head-mounted display 51 that is attached to the operator, and an image display unit 52 that displays images in the head-mounted display 51. Although the head-mounted display 51 and the image display unit 52 are connected to each other through a wire 53 in the figure, they may be wirelessly connected to each other. Note that, for example, the image display unit 52 may be incorporated into the head-mounted display 51. That is, the image display unit 52 and the head-mounted display 51 may be integrally formed.

The head-mounted display 51 is a specific example of the display means. The head-mounted display 51 is formed, for example, in the form of a pair of goggles and attached to the head of the operator. The head-mounted display 51 includes, for example, a liquid crystal display, an organic EL (Electronic Luminescent) display, or the like.

The head-mounted display 51 includes an angle sensor 54 that detects an angle(s) of the operator's head. The angle sensor 54 is a specific example of the direction detection means. The angle sensor 54 outputs the detected angle(s) of the operator's head to the image display unit 52.

For example, an angle in a state where the operator faces exactly forward is defined as 0° and the angle sensor 54 detects an angle in each of the yaw-axis and pitch-axis directions. Regarding the yaw-axis direction, a direction in a state where the operator faces the right is defined as a positive direction and a direction in a state where the operator faces the left is defined as a negative direction. Regarding the pitch-axis direction, a direction in a state where the operator faces upward is defined as a positive direction and a direction in a state where the operator faces downward is defined as a negative direction.

Note that although the angle of the operator's head is detected as a direction in which the operator faces in the above-described example, the present disclosure is not limited to this configuration. For example, a line of sight of the operator or a direction of his/her body may be detected as the direction in which the operator faces by using a camera or the like. That is, an arbitrary direction(s) may be detected as long as the direction which the operator is looking at can be determined based on the detected direction(s).

The image display unit 52 cuts out a predetermined range centered on the direction of the operator (i.e., the direction in which the operator is facing) from the entire area of the omnidirectional image of the image data transmitted from the image processing unit 23 of the moving object 2 based on the angle of the operator's head output from the angle sensor 54. The predetermined range is a predetermined area in the direction of the line of sight which the operator is looking at (hereinafter referred to as a line-of-sight direction area) and is defined in advance in a memory or the like.

For example, the image display unit 52 cuts out the predetermined area by specifying a line-of-sight direction area in the horizontal direction based on the angle of the operator's head in the yaw-axis direction output from the angle sensor 54 and specifying a line-of-sight direction area in the vertical direction based on the angle of the operator's head in the pitch-axis direction output from the angle sensor 54.

The image display unit 52 transmits an image of the line-of-sight direction area cut out from the entire area of the omnidirectional image of the image data to the head-mounted display 51. The head-mounted display 51 displays the image of the line-of-sight direction area transmitted from the image display unit 52 for the operator. In this way, the head-mounted display 51 can display an immersive image for the operator by displaying the image of the line-of-sight direction area corresponding to the direction in which the operator is facing.

Although the image display unit 52 and the controller device 4 are connected to each other through a wire in the above-described example, they may be wirelessly connected to each other. The image display unit 52 and the control device 3 may be communicatively connected through, for example, a network such as the Internet.

Incidentally, for example, when a moving object moves at a high speed, images displayed on the display device become discontinuous and hence there is a possibility that a sense of immersion of the operator is impaired. Therefore, the frame rate of the image in the display device is adjusted to a high value according to the high moving speed of the moving object. However, when the frame rate of the image in the display device is adjusted to the high value, the amount of communication for the image data transmitted from the camera to the display device increases and hence the communication load of the image data increases. Meanwhile, in some cases, an upper limit value for an amount of image data that can be transmitted per unit time is determined based on hardware for wired or wireless transmission of image data and hence image data cannot transmitted beyond the upper limit value. Therefore, it is desired to maintain a sense of immersion and reduce a communication load at the same time when a moving object is moving at a high speed.

To that end, the remote control system 1 according to the first embodiment increases the frame rate of image data taken by the camera 21 of the moving object 2 when the moving speed of the moving object 2 increases. Further, the remote control system 1 lowers the resolution of the image data taken by the camera 21 according to the increase in the frame rate.

As a result, when the moving object 2 is moving at a high speed, the frame rate of image data take by the camera 21 increases. However, since the resolution of the image data is lowered, the amount of communication for the image data is reduced, thus making it possible to reduce the communication load. Further, since the frame rate of image data taken by the camera 21 is maintained at a high value according to the moving speed of the moving object 2, it is possible to prevent images displayed in the display device 5 from becoming discontinuous and thereby to maintain the sense of immersion that the operator is feeling. That is, it is possible to maintain the sense of immersion and reduce the communication load at the same time when the moving object 2 is moving at a high speed.

In particular, when the moving object 2 is an underwater drone, its reaction speed in the water becomes lower. Therefore, as described above, the omnidirectional image around the moving object 2 is taken by an omnidirectional camera and a predetermined range in the direction in which the operator is facing is cut out from the omnidirectional image. Therefore, it is inevitable that the amount of image data transmitted from the moving object 2 increases. However, according to the remote control system 1 in accordance with the first embodiment, the amount of communication can be effectively reduced as described above. Therefore, it can be said that its reduction effect is more significant.

For example, when the image processing unit 23 of the moving object 2 determines that the moving speed of the moving object 2 detected by the speed sensor 22 has exceeded the predetermined value, the image processing unit 23 lowers the resolution of images of image data taken by the camera 21. The image processing unit 23 may lower the resolution of images of image data taken by the camera 21 when it determines that the frame rate of the image data has exceeded the predetermined value.

The image processing unit 23 can reduce the amount of communication between the image processing unit 23 of the moving object 2 and the image display unit 52 of the display device 5 by transmitting image data whose resolution has been changed to a low value to the image display unit 52. By doing so, the image processing unit 23 can reduce the communication load.

In the image processing unit 23, for example, a predetermined value(s) for the moving speed and an amount(s) of reduction in the resolution (hereinafter also referred to as a resolution reduction amount) with which the above-described maintenance of the sense of immersion and the reduction in the communication load can be achieved at the same time are defined in advance. When the image processing unit 23 determines that the moving speed of the moving object 2 detected by the speed sensor 22 has exceeded the predetermined value, the image processing unit 23 lowers the resolution of image data taken by the camera 21 by the predetermined resolution reduction amount.

Further, the image processing unit 23 may reduce the resolution of images of image data taken by the camera 21 as the moving speed of the moving object 2 detected by the speed sensor 22 increases. As a result, although the frame rate of image data take by the camera 21 increases as the moving speed of the moving object 2 increases, the communication load can be effectively reduced by gradually lowering the resolution of the image data. Therefore, it is possible to effectively reduce the amount of communication according to the moving speed of the moving object 2 and thereby to reduce the communication load.

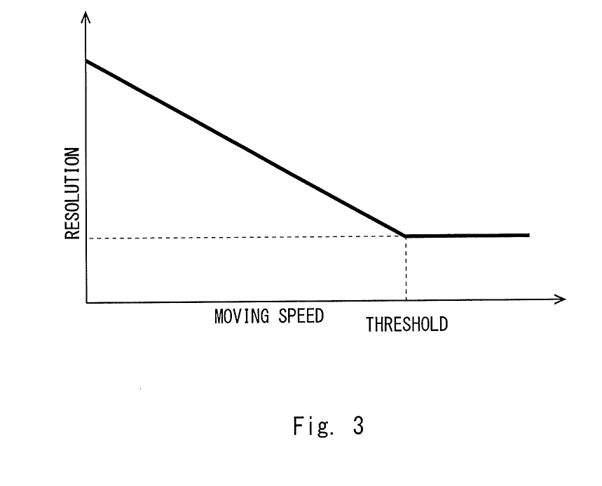

For example, as shown in FIG. 3, map information indicating a relation between moving speeds of the moving object 2 and resolutions is stored in the memory or the like. The image processing unit 23 lowers the resolution of images of image data taken by the camera 21 based on the moving speed of the moving object 2 detected by the speed sensor 22 and the map information. Note that in the map information, a relation indicating that the resolution decreases as the moving speed of the moving object 2 increases is defined. Further, according to the map information, when the moving speed becomes equal to or higher than a threshold, the resolution remains at a constant value. This is because if the resolution is lowered beyond this constant value, the operator cannot easily make out the image. The image processing unit 23 may lower the resolution of images of image data taken by the camera 21 by using an experimentally-obtained function or the like.

The image processing unit 23 may be incorporated into the control unit 3. In this case, the amount of communication between the control device 3 and the display device 5 can be reduced by the above-described configuration and hence the communication load can be reduced.

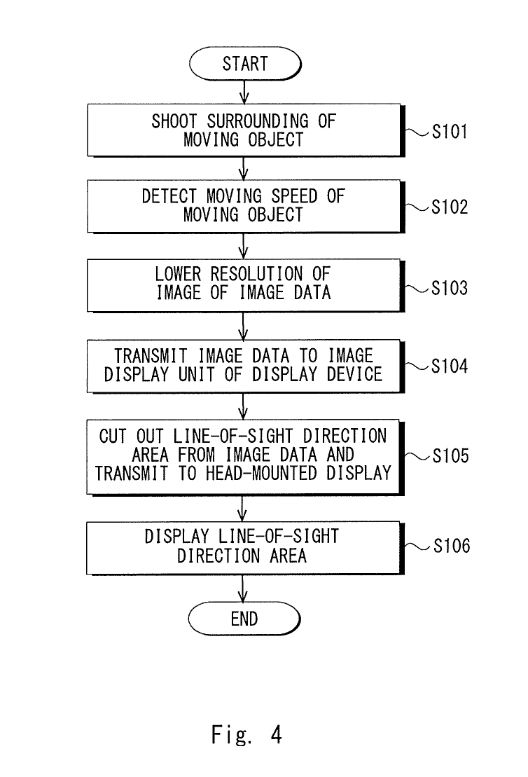

FIG. 4 is a flowchart showing a flow of a communication method performed by the remote control system according to the first embodiment.

The camera 21 shoots surroundings of the moving object 2 and transmits the image data thereof to the image processing unit 23 (step S101).

The speed sensor 22 detects the moving speed of the moving object 2 and transmits the detected moving speed to the image processing unit 23 (step S102).

The image processing unit 23 lowers the resolution of images of the image data transmitted from the camera 21 based on the image data and the moving speed of the moving object 2 transmitted from the speed sensor 22 according to the map information (step S103).

The image processing unit 23 transmits the image data whose resolution has been lowered to the image display unit 52 of the display device 5 through the wire 6 and the control device 3 (step S104).

The image display unit 52 transmits an image of the line-of-sight direction area, which is cut out from the entire area of the omnidirectional image of the image data transmitted from the image processing unit 23, to the head-mounted display 51 (step S105).

The head-mounted display 51 displays the image of the line-of-sight direction area transmitted from the image display unit 52 for the operator (step S106).

As described above, the remote control system 1 according to the first embodiment increases the frame rate of image data taken by the camera 21 of the moving object 2 when the moving speed of the moving object 2 increases. Further, the remote control system 1 lowers the resolution of the image data taken by the camera 21 according to the increase in the frame rate. As a result, when the moving object 2 is moving at a high speed, the frame rate of image data taken by the camera 21 increases. However, the communication load of the image data can be reduced by lowering the resolution of the image data. Further, since the frame rate of image data taken by the camera 21 is maintained at a high value according to the moving speed of the moving object 2, the sense of immersion that the operator is feeling can be maintained. That is, it is possible to maintain the sense of immersion and reduce the communication load at the same time when the moving object 2 is moving at a high speed.

### Second Embodiment

In a second embodiment according to the present disclosure, when the moving speed of the moving object 2 is higher than a predetermined value, the image processing section 23 of the moving object 2 defines a line-of-sight direction area in the entire area of the omnidirectional image of the image data taken by the camera 21 as a high image quality area and changes an area outside the line-of-sight direction area to a low image quality area having a resolution lower than that of the high image quality area.

In this way, the image processing unit 23 can maintain the high quality of the line-of-sight direction area that the operator is looking at and effectively reduce the communication load at the same time by transmitting the image data in which the resolution has been changed to a low resolution only in the area that the operator is not looking at to the image display unit 52 of the display device 5.

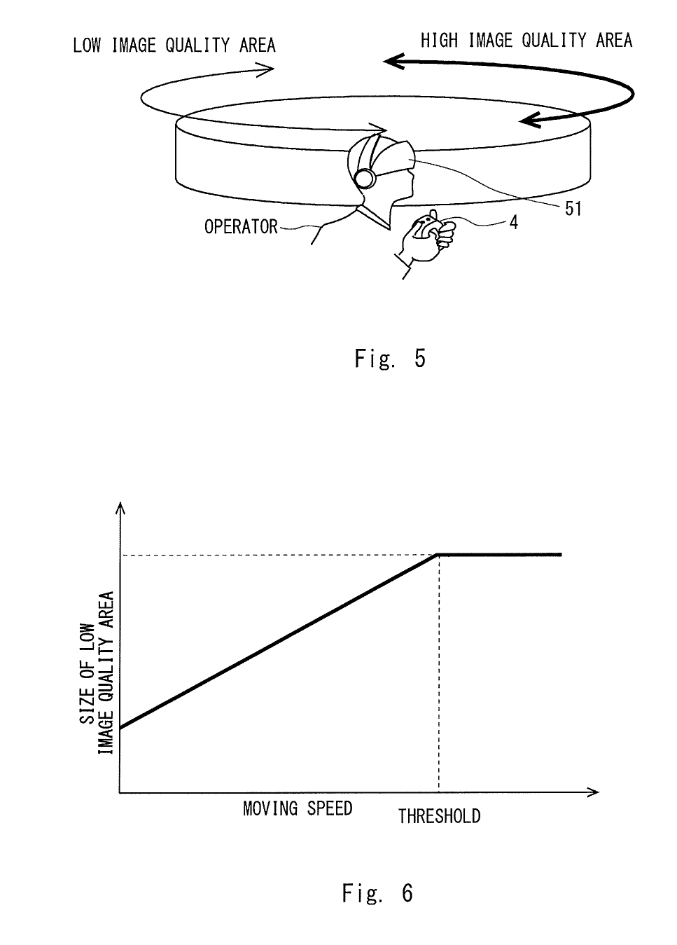

For example, as shown in FIG. 5, the image processing unit 23 defines a line-of-sight direction area in the entire area of the omnidirectional image of the image data as a high image quality area and changes an area outside the line-of-sight direction area to a low image quality area based on the angle of the operator's head transmitted from the angle sensor 54.

The predetermined range of the line-of-sight direction area is, for example, set (i.e., defined) in advance in the memory or the like, but the operator can arbitrarily change the setting through the controller device 4. Further, the image processing unit 23 may change the size of the low image quality area according to the moving speed of the moving object 2. For example, the image processing unit 23 may extend the low image quality area as the moving speed of the moving object 2 increases.

For example, as shown in FIG. 6, map information indicating a relation between moving speeds of the moving object 2 and sizes of the low image quality area is stored in the memory or the like. The image processing unit 23 extends the low image quality area based on the moving speed of the moving object 2 detected by the speed sensor 22 and the map information. Note that in the map information, a relation indicating that the size of the low image quality area increases as the moving speed of the moving object 2 increases is defined. Further, according to the map information, when the moving speed of the moving object 2 becomes equal to or higher than a threshold, the size of the low image quality area remains at a constant value. This is because if the size of the low image quality area is extended beyond this constant value, the operator cannot easily make out the image.

Although the image processing unit 23 changes a part of the entire area of the omnidirectional image of the image data to a low image quality area having the same resolution (i.e., having a uniform resolution) in the above-described example, the present disclosure is not limited to this configuration. The image processing unit 23 may divide a part of the entire area of the omnidirectional image of the image data into a plurality of low image quality areas in such a manner that resolutions of these low image quality areas gradually decrease in a stepwise manner or a continuous manner as the distance from the line-of-sight direction area increases. By doing so, it is possible to further reduce the amount of communication by lowering the image quality of an area(s) in the low image quality area that is less likely to be included in the field of view of the operator.

Further, when the moving speed of the moving object 2 is higher than the predetermined value, the image processing unit 23 may define an area around the angle of 0° in a state where the operator is facing exactly forward in the entire area of the omnidirectional image of the image data taken by the camera 21 as a high image quality area and gradually lower the resolution as the distance from the high image quality area increases.

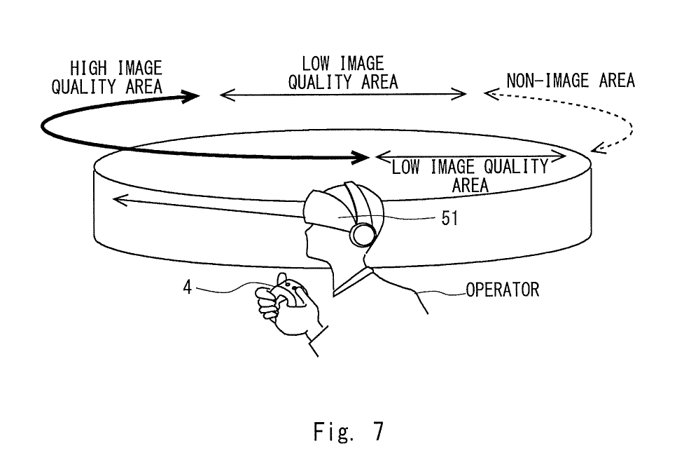

Further, for example, as shown in FIG. 7, the image processing unit 23 may define an area where there is no image (hereinafter also referred to as a non-image area) in a part of the low image quality area. For example, the image processing unit 23 estimates an area in the low image quality area that the operator cannot see based on a communication delay time that occurs when the angle of the operator's head is transmitted from the angle sensor 54 to the image processing unit 23 and a maximum moving speed of the operator's head. This area is an area that the operator cannot see even when the operator moves his/her head at the maximum moving speed. Then, the image processing unit 23 defines the estimated area as a non-image area. In this way, by changing a part of the low image quality area to a non-image area where there is no image data in addition to changing the area that the operator is not looking at to the low image quality area, it is possible to further reduce the amount of communication and thereby to reduce the communication load.

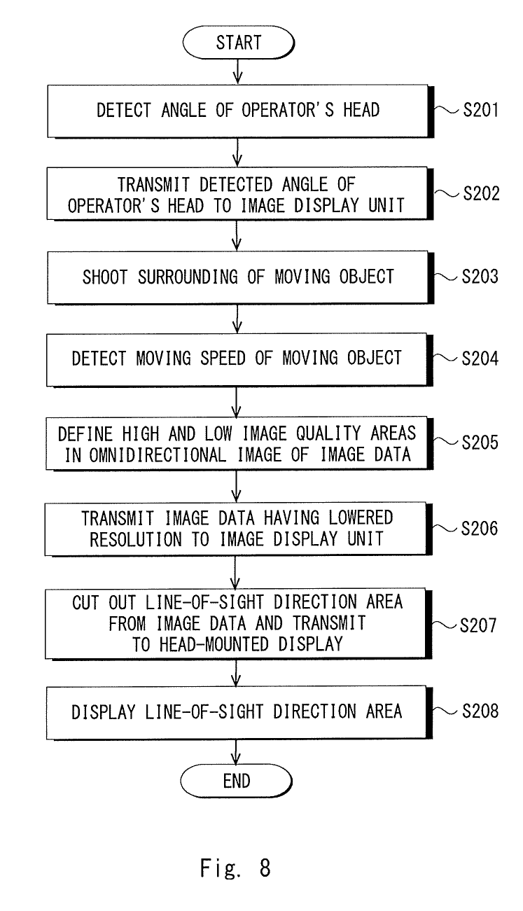

FIG. 8 is a flowchart showing a flow of a communication method performed by the remote control system according to the second embodiment.

The angle sensor 54 of the head-mounted display 51 detects the angle of the operator's head (step S201). The angle sensor 54 transmits the detected angle of the operator's head to the image display unit 52 (step S202).

The camera 21 of the moving object 2 shoots surroundings of the moving object 2 and transmits the image data thereof to the image processing unit 23 (step S203).

The speed sensor 22 detects the moving speed of the moving object 2 and transmits the detected moving speed to the image processing unit 23 (step S204).

The image processing unit 23 defines a high image quality area and a low image quality area in the omnidirectional image of the image data based on the angle of the operator's head transmitted from the angle sensor 54, the moving speed of the moving object 2 transmitted from the speed sensor 22, and the map information (step S205). The image processing unit 23 lowers the resolution of the defined low image quality area in the image data.

The image processing unit 23 transmits the image data whose resolution has been lowered to the image display unit 52 of the display device 5 through the wire 6 and the control device 3 (step S206).

The image display unit 52 transmits an image of the line-of-sight direction area, which is cut out from the entire area of the omnidirectional image of the image data transmitted from the image processing unit 23, to the head-mounted display 51 (step S207).

The head-mounted display 51 displays the image of the line-of-sight direction area transmitted from the image display unit 52 for the operator (step S208).

### Third Embodiment

In a third embodiment according to the present disclosure, when the moving speed of the moving object 2 is higher than the predetermined value, the image processing section 23 of the moving object 2 may lower the resolution of image data taken by the camera 21 of the moving object 2 and decrease the resolution reduction amount for the image data according to a depth of the moving object 2.

When the moving object 2 dives deep into the water and hence the depth of the moving object 2 increases, surroundings of the moving object 2 become darker. Therefore, the exposure time of the camera 21 becomes longer and its frame rate decreases. Consequently, the amount of image data taken by the camera 21 decreases. Therefore, the image processing unit 23 decreases the resolution reduction amount as the depth of the moving object 2 increases as described above. In this way, the communication load can be optimally reduced according to the depth of the moving object 2.

For example, when the moving speed of the moving object 2 is higher than the predetermined value, the image processing section 23 lowers the resolution of image data taken by the camera 21 of the moving object 2 and decreases the resolution reduction amount for the image data as the depth of the moving object 2 detected by a depth sensor increases.

More specifically, map information indicating a relation between depths of the moving object 2 and resolution reduction amounts is stored in the memory or the like. In the map information, a relation indicating that the resolution reduction amount decreases as the depth of the moving object 2 increases is stored.

When the image processing unit 23 determines that the moving speed of the moving object 2 detected by the speed sensor 22 exceeds the predetermined value, the image processing unit 23 calculates the resolution reduction amount corresponding to the depth of the moving object 2 by referring to the map information. The image processing unit 23 lowers the resolution of the image data taken by the camera 21 of the moving object 2 by the calculated resolution reduction amount.

When the moving speed of the moving object 2 is higher than the predetermined value, the image processing section 23 may lower the resolution of the image data taken by the camera 21 of the moving object 2 and decreases the resolution reduction amount for the image data according to a degree of transparency of water around the moving object 2.

When the transparency of water around the moving object 2 decreases, surroundings of the moving object 2 become darker. Therefore, the exposure time of the camera 21 becomes longer and its frame rate decreases. Consequently, the amount of image data taken by the camera 21 decreases. Therefore, the image processing unit 23 decreases the resolution reduction amount as the degree of transparency of water around the moving object 2 decreases as described above. In this way, the communication load can be optimally reduced according to the degree of transparency of water around the moving object 2.

For example, the image processing unit 23 can calculate the degree of transparency of water around the moving object 2 based on the image of the surrounding of the moving object 2 taken by the camera 21.

When the moving speed of the moving object 2 is higher than the predetermined value, the image processing section 23 may lower the resolution of the image data taken by the camera 21 of the moving object 2 and decreases the resolution reduction amount for the image data as the degree of transparency of water around the moving object 2 decreases.

More specifically, map information indicating a relation between degrees of transparency of water around the moving object 2 and resolution reduction amounts is stored in the memory or the like. In the map information, a relation indicating that the resolution reduction amount decreases as the degree of transparency of water around the moving object 2 decreases is stored.

When the image processing unit 23 determines that the moving speed of the moving object 2 detected by the speed sensor 22 has exceeded the predetermined value, the image processing unit 23 calculates the resolution reduction amount corresponding to the degree of transparency of water around the moving object 2 by referring to the map information. The image processing unit 23 reduces the resolution of the image data taken by the camera 21 of the moving object 2 by the calculated resolution reduction amount.

### Fourth Embodiment

In a fourth embodiment according to the present disclosure, when the moving speed of the moving object 2 is higher than the predetermined value, the image processing section 23 of the moving object 2 may lower the resolution of the image data taken by the camera 21 of the moving object 2 and increase the resolution reduction amount for the image data as the distance between the moving object 2 and the control device 3 increases.

In the case where the image processing unit 23 of the moving member 2 and the control device 3 are wirelessly connected to each other, when image data is transmitted from the image processing unit 23 to the control unit 3, the image data is transmitted between them through the water. Further, as the distance between the moving object 2 and the control device 3, i.e., the distance of the path in the water through which the image data passes increases, attenuation of the signal of the image data increases. Consequently, the upper limit value for the amount of image data that can be transmitted per unit time decreases. Therefore, as described above, the image processing unit 23 increases the resolution reduction amount for the image data and thereby decreases the amount of communication as the distance between the moving object 2 and the control device 3 increases. In this way, the communication load can be optimally reduced according to the distance between the moving object 2 and the control device 3.

For example, the image processing unit 23 calculates the distance between the moving object 2 and the control unit 3 based on the image taken by the camera 21. When the moving speed of the moving object 2 is higher than the predetermined value, the image processing section 23 may lower the resolution of the image data taken by the camera 21 of the moving object 2 and increases the resolution reduction amount for the image data as the calculated distance between the moving object 2 and the control device 3 increases.

More specifically, map information indicating a relation between distances between the moving object 2 and the control device 3 and resolution reduction amounts is stored in the memory or the like. In the map information, a relation indicating that the resolution reduction amount increases as the distance between the moving object 2 and the control device 3 increases is stored.

When the image processing unit 23 determines that the moving speed of the moving object 2 detected by the speed sensor 22 has exceeded the predetermined value, the image processing unit 23 calculates the resolution reduction amount corresponding to the distance between the moving object 2 and the control device 3 by referring to the map information. The image processing unit 23 reduces the resolution of the image data taken by the camera 21 of the moving object 2 by the calculated resolution reduction amount.

Several embodiments according to the present disclosure have been explained above. However, these embodiments are shown as examples but are not shown to limit the scope of the disclosure. These novel embodiments can be implemented in various forms. Further, their components/structures may be omitted, replaced, or modified without departing from the scope and spirit of the disclosure. These embodiments and their modifications are included in the scope and the spirit of the disclosure, and included in the scope equivalent to the disclosure specified in the claims.

For example, although the unmanned submersible apparatus is described as the moving object 2 in the above-described embodiments, the moving object 2 is not limited to the unmanned submersible apparatus. The moving object 2 can be applied to various types of moving objects 2 such as unmanned airplanes, unmanned ships, unmanned vehicles, construction/earth-moving robots such as unmanned earth-moving machines, and humanoid robots.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A remote control system comprising:
a moving object comprising: shooting means; and image quality changing means for changing a resolution of image data taken by the shooting means;
controller means by which an operator remotely controls the moving object; and
display means for cutting out a predetermined range from an image of the image data transmitted from the image quality changing means of the moving object according to a direction in which the operator is facing and displaying an image of the cut-out predetermined range for the operator, the display means being configured to be attached to the operator operating the controller means, wherein
the image quality changing means increases a frame rate of the image data taken by the shooting means and lowers the resolution of the image data according to the increase in the frame rate when at least one of following conditions is satisfied:
a condition that a moving speed of the moving object increases; and
a condition that a setting is changed through the controller means so that the frame rate of the image data taken by the shooting means increases.

2. The remote control system according to claim 1, wherein
the display means comprises direction detection means for detecting a direction in which the operator is facing,
the display means displays the image of the predetermined range included in the image data changed by the image quality changing means for the operator, the predetermined range being a range centered on the direction in which the operator is facing detected by the direction detection means, and
the image quality changing means lowers the resolution of the image data taken by the shooting means by defining an area in the predetermined range in the image data centered on the direction in which the operator is facing detected by the direction detection means as a high image quality area and changing an area outside the predetermined range to a low image quality area having a resolution lower than that of the high image quality area.

3. The remote control system according to claim 2, wherein the image quality changing means extends the low image quality area as the frame rate of the image data taken by the shooting means increases.

4. The remote control system according to claim 2, wherein the image quality changing means estimates an area in the low image quality area that the operator cannot see based on a moving speed of a head of the operator and sets the estimated area as a non-image area where there is no image.

5. The remote control system according to claim 2, wherein the image quality changing means gradually lowers the resolution of the low image quality area as a distance from the high image quality area increases.

6. The remote control system according to claim 1, wherein the image data is transmitted from the image quality changing means to the display means wirelessly or through a wire, and
an upper limit value for an amount of communication per unit time for transmission of the image data is set for the wireless transmission of the wired transmission.

7. The remote control system according to claim 1, wherein the image quality changing means lowers the resolution of the image data taken by the shooting means when the frame rate of the image data taken by the shooting means is higher than a predetermined value.

8. The remote control system according to claim 1, wherein the shooting means is an omnidirectional camera configured to omnidirectionally shoot the moving object.

9. The remote control system according to claim 1, wherein the moving object is a submersible apparatus configured to move under water.

10. The remote control system according to claim 9, wherein the image quality changing means lowers the resolution of the image data taken by the shooting means according to an increase in the frame rate of the image data and decreases an amount of reduction in the resolution according to a depth of the moving object or a degree of transparency of water around the moving object.

11. The remote control system according to claim 9, wherein the image data whose resolution has been changed by the image quality changing means is wirelessly transmitted from the image quality changing means to the display means through water, and
the image quality changing means lowers the resolution of the image data taken by the shooting means according to an increase in the frame rate of the image data and increase an amount of reduction in the resolution according to a distance of wireless transmission in the water.

12. A communication method for a remote control system, the remote control system comprising:
a moving object comprising: shooting means; and image quality changing means for changing a resolution of image data taken by the shooting means;
controller means by which an operator remotely controls the moving object; and
display means for cutting out a predetermined range from an image of the image data transmitted from the image quality changing means of the moving object according to a direction in which the operator is facing and displaying an image of the cut-out predetermined range for the operator, the display means being configured to be attached to the operator operating the controller means,
the communication method comprising:
increasing a frame rate of the image data taken by the shooting means and lowering the resolution of the image data according to the increase in the frame rate when at least one of following conditions is satisfied:
a condition that a moving speed of the moving object increases; and
a condition that a setting is changed through the controller means so that the frame rate of the image data taken by the shooting means increases.

13. A remote control system comprising:
a moving object comprising: a camera; and an image quality changing unit configured to change a resolution of image data taken by the camera;
a controller by which an operator remotely controls the moving object; and
a display configured to cut out a predetermined range from an image of the image data transmitted from the image quality changing unit of the moving object according to a direction in which the operator is facing and displaying an image of the cut-out predetermined range for the operator, the display being configured to be attached to the operator operating the controller, wherein
the image quality changing unit increases a frame rate of the image data taken by the camera and lowers the resolution of the image data according to the increase in the frame rate when at least one of following conditions is satisfied:
a condition that a moving speed of the moving object increases; and
a condition that a setting is changed through the controller so that the frame rate of the image data taken by the camera increases.
